(19) United States
(12) Patent Application Publication
(10) Pub. No.: US 2021/0049520 A1
(43) Pub. Date: Feb. 18, 2021

(54) INTEGRATING TRANSPORTATION SERVICES AND FACILITY ACCESS SERVICES THROUGH A CALENDAR SYSTEM

(71) Applicant: Ford Global Technologies, LLC, Dearborn, MI (US)

(72) Inventors: Thomas MIKULSKI, Dearborn, MI (US); Yifan CHEN, Dearborn, MI (US)

(21) Appl. No.: 16/977,123

(22) PCT Filed: Mar. 9, 2018
(86) PCT No.: PCT/US18/21744

§ 371 Date: Sep. 1, 2020

(51) Int. Cl. G06Q 10/02; G06Q 10/10; G06F 16/242; G06F 16/2457; G06Q 50/30

(52) U.S. Cl. CPC G06Q 10/02; G06Q 10/1095; G06Q 50/30; G06F 16/24575; G06F 16/2428

(57) ABSTRACT

The present invention extends to methods, systems, and computer program products for integrating transportation services and facility access services through a calendar system. A client application used to access a calendar system can also include integrated user interface controls for scheduling rides from a transportation service. When a ride is confirmed, the application can also request (e.g., key card) access to a building at the ride's destination. Integrating transportation services and facility access services though a calendar system reduces context switching between different applications. Reduced context switching streamlines scheduling of transportation for events (e.g., corporate meetings), which may result in individuals requesting transportation to an event along with (or at least closer in time to) the scheduling the event. The earlier in time a transportation service receives transportation requests, the better the transportation service can optimize resource allocation to satisfy transportation requests.

### BACKGROUND

### 1. Field of the Invention

This invention relates generally to the field of mobility solutions, and, more particularly, to integrating transportation services and facility access services through a calendar system.

### 2. Related Art

Scheduling events and participating in scheduled events, such as, business meetings, often requires meeting participants to interface with several different services. For example, to participate in a corporate meeting, a meeting participant can interface with a corporate calendar service to schedule a meeting, a separate corporate transportation service to schedule travel to the meeting, and a separate corporate security service to gain access to a building. Each service can require information from the participant operate.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIGS. 2A and 2B illustrate an example computer architecture that facilitates integrating transportation services and facility access services through a calendar system.

FIG. 3 illustrates a flow chart of an example method for integrating transportation services and facility access services through a calendar system.

FIG. 4A illustrates an application user interface.

FIG. 4B illustrates an application user interface screen.

FIG. 4C illustrates the application user interface of FIG. 4A

FIG. 4D illustrates the application user interface screen of FIG. 4B.

FIG. 5 illustrates another application user interface.

FIG. 6 illustrates a user interface including a map to a meeting location.

FIG. 7 illustrates a trip reminder.

### DETAILED DESCRIPTION

The present invention extends to methods, systems, and computer program products for integrating transportation services and facility access services through a calendar system.

Generally, when participating in an event (e.g., a meeting), an individual can use a calendar system to perform one or more of: scheduling the event, sending event invitations, or receiving event invitations. The individual may then switch to a transportation service (e.g., a corporate shuttle service) to arrange for transportation to and/or from the event. Transportation can include pickup from a starting location (e.g., outside a building containing the individual's office) and drop off at an ending location (e.g., outside another building containing a conference room to be used for a meeting). The individual may further switch to a security service or interact with security personnel to gain authorization to enter a facility (e.g., the building containing the conference room). Each different service can be siloed from the other services, making end to end transportation and access to events cumbersome.

Further, each different service can request participant information. The participant may have to redundantly search for and/or enter information (possibly multiple times), even though the information is already accessible from other systems. For example, a corporate transportation service may require a participant to manually enter a starting location, an ending location, and a pickup time to request transportation. However, the starting locating may be the participant's building location, included in a corporate human resources database. An ending location may be indicated in a meeting item contained in a calendar system. A pickup time may be derived from the time of the meeting (indicated in the meeting item) in view of travel time between the starting and ending locations.

Upon reaching an ending location, such as, a building containing a conference room, the participant may not have access the building. The participant may have to contact another person already in the building or contact security personal for access. However, if the participant is already a badged employee, a corporate security database may contain the participants information. Interfacing with multiple separate services to participate in a meeting reduces employee productivity.

Aspects of the invention integrate transportation services and facility access services for event participants through a calendar system. A client application for accessing a calendar system can also include user interface controls for scheduling rides from a transportation service. When a ride is confirmed, the application can also request physical (e.g., key card) access to a building at the ride's destination from a security service. Integrating transportation services and facility access services though a calendar system reduces context switching between different applications. Reduced context switching streamlines scheduling of transportation for events (e.g., corporate meetings), which may result in individuals requesting transportation to an event along with (or at least closer in time to) scheduling the event. The earlier in time a transportation service receives transportation requests, the better the transportation service can optimize resource allocation to satisfy transportation requests.

In one aspect, a calendaring system application communicates with other modules and databases, including one or more of: a request builder, a human resources/calendar database, a trip management service, a routing database, a security service, and a security database. A meeting participant can request a trip reservation through the calendaring system application. Information from the human resources/calendar database can be used to pre-populate the request (reducing manual data entry) with relevant information about the participant and/or the event. The calendaring system application can provide a user interface screen permitting the meeting participant to modify pre-populated information as well as request a return trip. The pre-populated request, including any modifications, is sent to the trip management service. Based on information in the pre-populated request and (e.g., fleet) information in the routing database, the trip management service schedules a trip satisfying the pre-populated request.

Based on information for the trip, the calendaring system application also formulates a building access request to request temporary building access for the meeting participant. The calendaring system application sends the building access request to the security service. The security service processes the building access request and updates the security database to reserve temporary building access for the meeting participant around the time of the meeting. The security service can also generate a map from a building entrance to the location of the event within a building. Thus, upon exiting a vehicle, the meeting participant can efficiently proceed to the meeting location.

For example, upon arrival, the calendaring system application can direct the meeting participant to a building entrance of a building where a meeting is located. The participant can enter the building unassisted (based on temporary building access) and can follow directions to a conference room. The calendaring system application can also indicate when other meeting participants are estimated to arrive at the meeting.

In one aspect, a trip can be reserved via a single click user interface model.

Accordingly, aspects provide a streamlined experience for meeting participants to reserve a trip and get to a meeting. Context switching between different applications is reduced in turn lowering barriers associated with scheduling and participating in meetings. From a participant perspective, reducing context switching increases the likelihood of participants scheduling meetings and reserving trips earlier. For example, the efficiency of scheduling a trip to attend an in-person meeting can approach the efficiency of clicking a link to join a web based meeting.

Earlier scheduling of meetings and trips provides advantages to corporate infrastructure as well. The earlier a transportation service has knowledge of a trip, the better the transportation service can optimize allocation of fleet resources to meet overall transportation demands.

Further, providing short-term building access through a security database facilitates better security tracking relative to other forms of building entry, such as, others opening a door to let in a meeting participant. Based on provided short-term access, a security service has knowledge that a meeting participant was likely in a building during the time of a scheduled meeting.

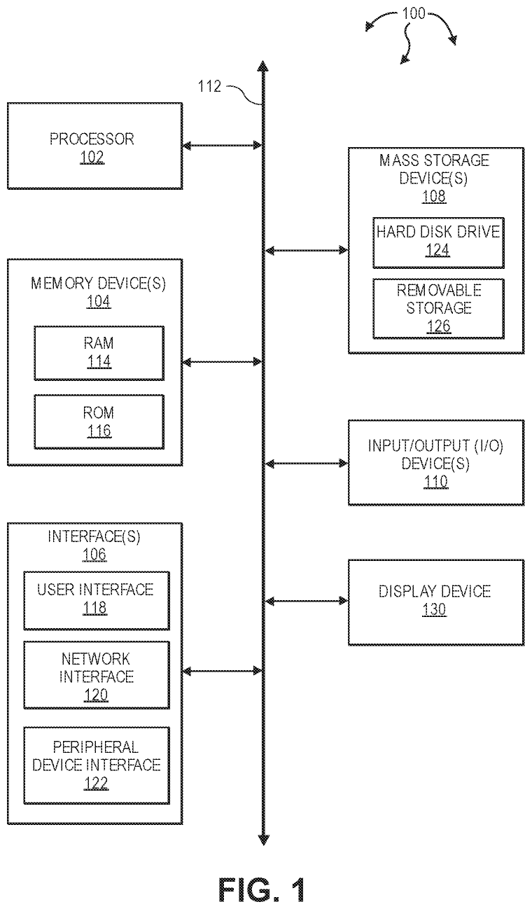

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, radars, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

In this description and the following claims, a “calendaring system” is defined as a (software and/or hardware) system that provides users with an electronic version of a calendar. A calendaring system can also provide an appointment book, an address book, a contact list, etc. A calendar system can be networked to share calendar information, such as, for example, events, meetings, etc., between users. Different devices can include applications that access calendaring information from a common calendaring database of a calendaring system.

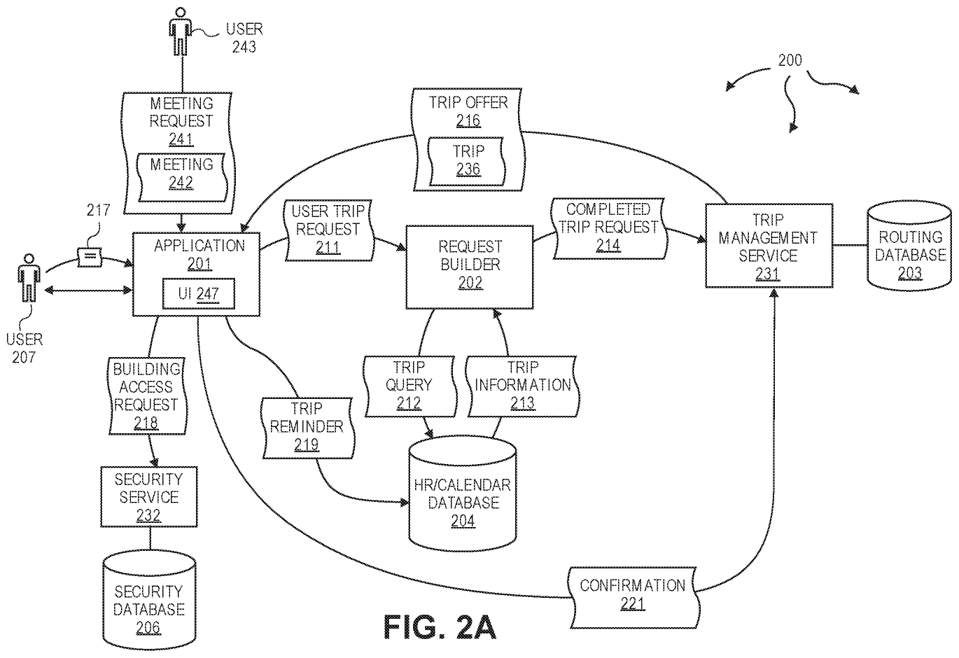

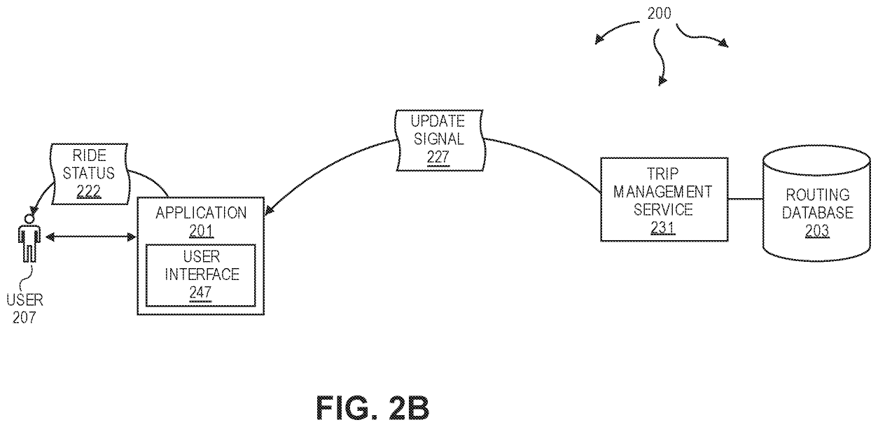

FIG. 2A illustrates an example computer architecture 200 that facilitates integrating transportation services and facility access services through a calendar system. As depicted, computer architecture 200 includes application 201, request builder 202, trip management service 231, routing database 203, human resources/calendar database 204, security service 232, and security database 206. Application 201, request builder 202, trip management service 231, routing database 203, human resources/calendar database 204, security service 232, and security database 206 can be connected to (or be part of) a network, such as, for example, a system bus, a Local Area Network (“LAN”), a Corporate Area Network (“CAN”), a Wide Area Network (“WAN”), and even the Internet. Accordingly, application 201, request builder 202, trip management service 231, routing database 203, human resources/calendar database 204, security service 232, and security database 206 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Application 201 can be a client application for a calendaring system. User 207 can interact with the calendaring system through user interface 247. In one aspect, application 201 is also a client application for one or more of: an email system, a contacts system, and a task management system. User interface 247 can include user interface controls for interacting with any of the described systems.

In one aspect, user interface 247 includes buttons and forms for interacting with the calendaring system to facilitate “one-click” reservation of transportation and building access. User 201 can interact with the buttons and forms to send a user trip request to request builder 202

Human resources/calendar database 204 can include calendar data, human resources data, etc. for a number of calendaring system users (including user 207). In one aspect, the users are corporate employees that use a corporate calendaring system. Request builder 202 is configured to receive a user trip request from application 201. Request builder 202 can access relevant information about user 207, a meeting user 207 is to attend, etc., from human resources/calendar database 204. Request builder 202 can auto populate fields of the user trip request with the relevant information (relieving the user from manually entering the relevant information) to form a completed trip request. Request builder 202 can send the completed trip request to trip management service 231 to request a trip.

Trip management service 231 can receive a completed trip request from request builder 202. Based on information in the completed trip request and (e.g., fleet) vehicle information in routing database 203, trip management service 231 can schedule a trip that satisfies the completed trip request. Routing database 203 can include trip and other data for a plurality of vehicles (e.g., in a fleet, used for a corporate shuttle service, etc.).

The trip and other data can include planned trips, active trips, maintenance status, vehicle availability, vehicles in service, etc., for each of the plurality of vehicles. A scheduled trip can include dispatching a vehicle to pick up user 207 from a start location and at a start time, physically transporting user 207 from the start location to an end location in the vehicle, and the vehicle arriving at an end location around an end time to drop off user 207. Vehicles can be driver operated and/or can include some level autonomous operation, including fully autonomous vehicles.

In one aspect, trip management service 231 formulates a trip that potentially satisfies a received trip request and sends a trip offer for the formulated trip to application 201. Application 201 can receive the trip offer and present the formulated trip at user interface 247. User 207 can confirm acceptance of the formulated trip or reject the formulated trip using interface controls at user interface 247. If user 207 rejects the formulated trip, application 201 can send a rejection back to trip management service 231. In response to receiving a rejection, trip management service 231 can formulate another trip that potentially satisfies the received trip request. When formulating the other trip, trip reservation service can refine formulation of the other trip based on the content of previously rejected trips (e.g., to remove trip properties appearing undesirable to user 207).

If user 207 confirms the formulated trip, a confirmation can be sent back to trip management service 231. In response to receiving a confirmation, trip management service 231 updates routing database 203 with the formulated trip. If user 207 confirms the formulated trip, application 201 can also store a trip reminder in calendar database 204. The trip reminder can trigger messages back to application 201 to reminder user 207 about the trip.

If user 207 confirms the formulated trip, application 201 can also send a building access request to security service 232. Security service 232 can receive a building access request from application 201. A building access request can include a user identifier (e.g., an employee number for user 207), a meeting time, a meeting location, etc. Security service 232 can update security database 206 to provide user 207 with temporary physical access to the meeting location (e.g., a building) around the meeting time (e.g., from 5-10 minutes before a scheduled meeting start time to 5-10 minutes after the scheduled meeting start time).

From time to time, trip management service 231 can send status signals to application 201 indicating status of the reserved trip (e.g., confirmed, on schedule, vehicle maintenance issue, traffic congestion, other delay, etc.). Application 201 can receive status signals from trip management service 231 and indicate the status of the reserved trip to user 207 through user interface 247.

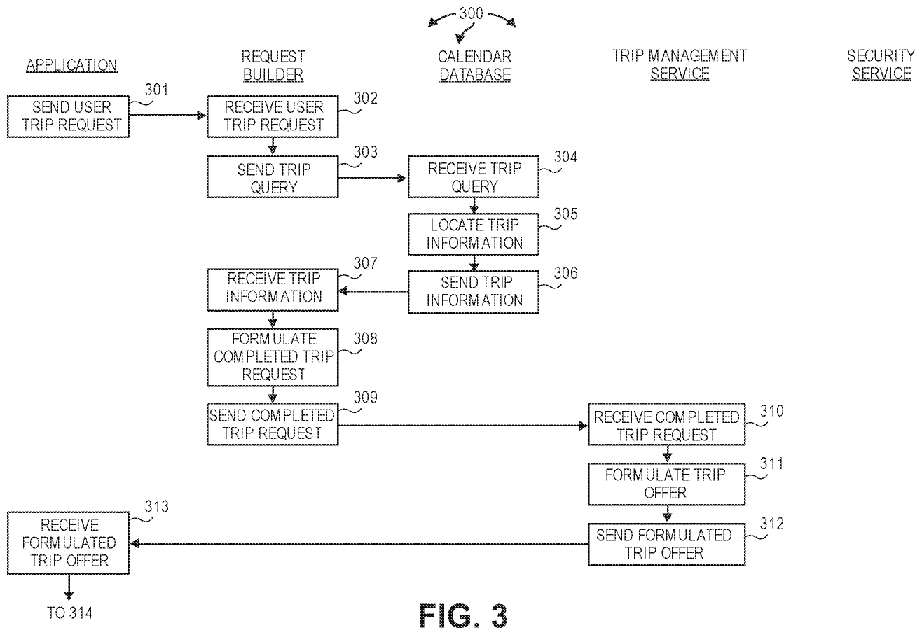

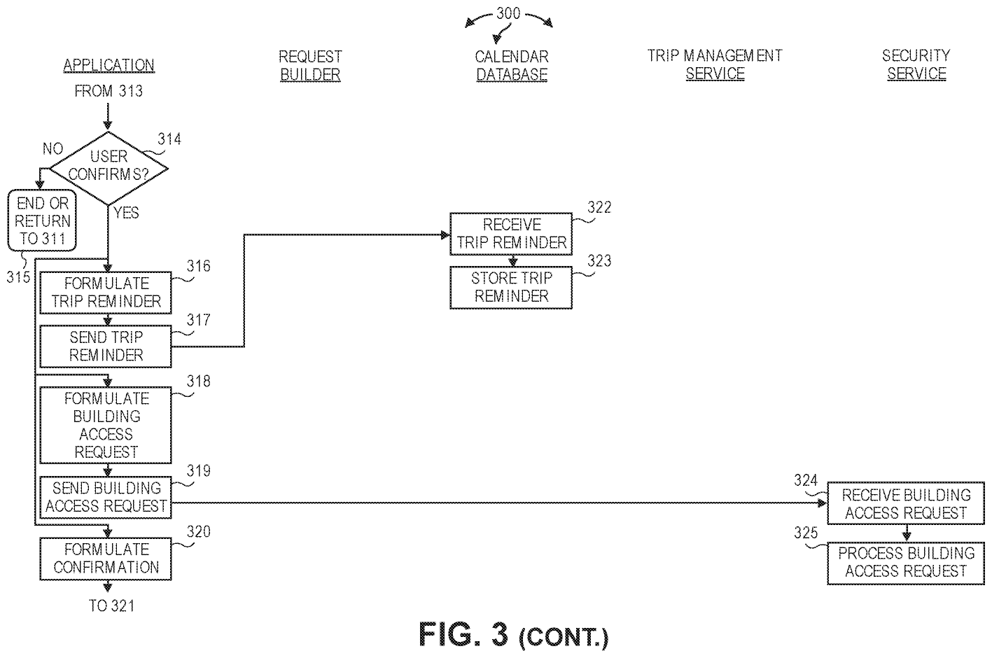

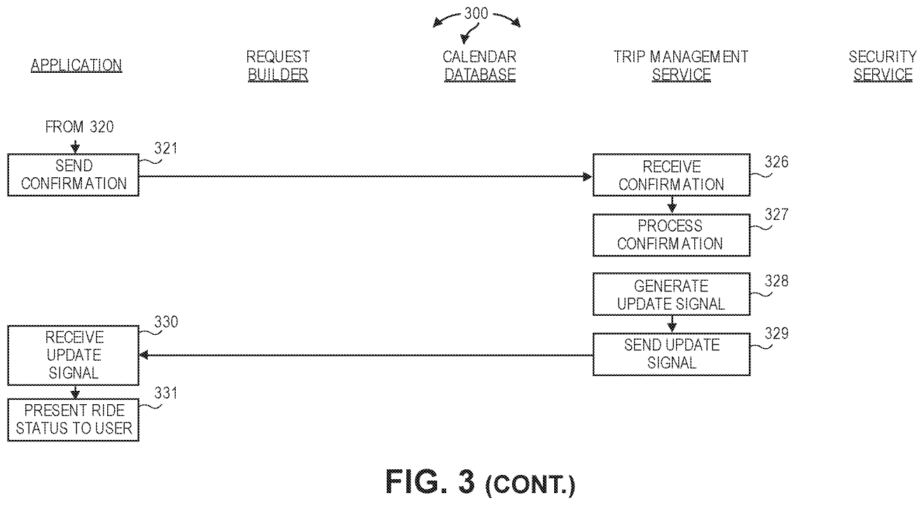

FIG. 3 illustrates a flow chart of an example method 300 for integrating transportation and facility access services through a calendar system. Method 300 will be described with respect to the components and data in computer architecture 200.

In one aspect, user 207 has an office in a building on a corporate campus. User 243 can send meeting request 241 to invite user 207 to participate in meeting 242. Meeting request 241 can include a date, a time, and a location for meeting 242. For example, meeting request 241 can be a request to attend a meeting at a specified date and time in a conference room in another building on the corporate campus. Through user interface controls at user interface 247, user 207 can accept meeting request 241 to attend meeting 242. Upon acceptance, application 201 can update calendaring database 204 (either directly or through a calendaring system) with details of meeting 242 (e.g., date, start time, end time, building, conference room, etc.). Along with acceptance of meeting request 241, user 207 can also interact with user interface controls of user interface 247 (e.g., by clicking a button), to request a ride from their building to the other building attend meeting 242.

Method 300 includes sending a user trip request (301). For example, application 201 can formulate user trip request 211 associated with acceptance of meeting request 241. Application 201 can send user trip request 211 to trip request builder 202. Method 300 includes receiving a user trip request (302). For example, request builder 202 can receive user trip request 211 from application 201. User trip request 211 can include data identifying user 207 (e.g., a user ID) and/or data identifying meeting 242 (e.g., a meeting ID).

Method 300 includes sending a trip query (303). For example, request builder 202 can use data identifying user 207 and/or data identifying meeting 242 to formulate trip query 212. Request builder 202 can send trip query 212 to human resources/calendar database 204. Method 300 includes receiving a trip query (304). For example, human resources/calendar database 204 can receive trip query 212 from request builder 202. Trip query 212 can be configured to query for details associated with user 207 (e.g., building/office location) and/or details associated with meeting 242 (e.g., date, start time, end time, building, and conference room).

Method 300 includes locating trip information (305). For example, human resources/calendar database 204 can locate trip information 213. Trip information 213 can include details associated with user 207 (e.g., building/office location) and/or details associated with meeting 242 (e.g., date, start time, end time, building, and conference room). Method 300 includes sending the trip information (306). For example, human resources/calendar database 204 can send trip information 213 to request builder 202.

Method 300 includes receiving trip information (307). For example, request builder 202 can receive trip information 213 from calendar database 213. Method 300 includes formulating a completed trip request (308). For example, request builder 202 can auto populate completed trip request 214 with details of user 207 (e.g., building/office location) and/or meeting 242 (e.g., date, start time, end time, building, conference room, etc.) included in trip information 213. Method 300 includes sending the completed trip request (309). For example, request builder 202 can send completed trip request 214 to trip management service 231.

Method 300 includes receiving the completed trip request (310). For example, trip management service 231 can receive completed trip request 214 from request builder 202. Method 300 includes formulating a trip offer (311). For example, based on the building/office location of user 207, the date, the start time, and building for meeting 242, and vehicle (e.g., fleet) data in routing database 203, trip management service 231 can determine that trip 236 purportedly satisfies travel requirements to get user 207 to meeting 242 around (e.g., within 5 minutes of) the start time. Trip management service 231 can formulate trip offer 216 including trip 236.

Method 300 includes sending the formulating trip offer (312). For example, trip management service 231 can send trip offer 216 to application 201. Method 300 includes receiving the formulating trip offer (313). For example, application 201 can receive trip offer 216 from trip management service 231.

Method 300 includes determining if the user confirms the formulated trip offer (decision block 314). For example, user 207 can be presented options at user interface 247 to confirm or reject trip offer 216. User 207 can supply input 217 confirming or rejecting trip offer 216.

If trip offer 216 is rejected (NO at 314), method 300 includes ending or returning to 311 (315). In response to rejection, trip management service 231 can formulate a different trip offer that purportedly satisfies travel requirements to get user 207 to meeting 242 around start time. The different trip offer can consider properties of trip 236 that may have caused trip offer 236 to be rejected. A new trip offer for the different trip can be sent to application 201 for user confirmation. Trip management service 231 can iteratively formulate additional different trip offers until confirmation or until an end condition (e.g., a specified number of iterations, no alternate trips are available, etc.) is satisfied. Method 300 can end when an end condition is satisfied. User 207 can restart method 300 at a later time, for example, when the status of vehicles managed by trip management service 231 has changed.

If trip offer 216 is confirmed (YES at 314), method 300 includes formulating a trip reminder (316) and sending the trip reminder (317). For example, application 201 can formulate trip reminder 219 and send trip reminder 219 to calendar database 204. Method 300 includes receiving the trip reminder (322) and storing the trip reminder (323). For example, calendar database 204 can receive trip reminder 219 from application 201 and store trip reminder 219. Trip reminder 219 can trigger one or more reminders at user interface 247 some amount of time (e.g., 5 minutes, 15 minutes, an hour, etc.) before trip 236 is scheduled to begin.

If trip offer 216 is confirmed (YES at 314), method 300 includes formulating a building access request (318) and sending the building access request (319). For example, application 201 can formulate building access request 218 and send building access request 218 to security service 232. Building access request 218 can include a date and starting time for meeting 242, the distance and/or travel time from the building (containing user 207's office) to the other building (containing the conference room), trip information for trip 236 (e.g., estimated time of arrival at the other building), employee ID for user 207, etc. Application 201 can send building access request 218 to security service 232.

Method 300 includes receiving the building access request (324) and processing the building access request (325). For example, security service 232 can receive building access request 218 from application 201. Security service 232 can process building access request 218 to provide user 207 with temporary physical access to the other building. Temporary access can be for a time period around the time of meeting 242 (e.g., from 5-10 minutes before the scheduled start time of meeting 242 to 5-10 minutes after the scheduled start time of meeting 242). Security service 232 can update security database 206 to indicate the time period user 207 is provided physical access to the other building. In one aspect, user 207's access card is temporarily authorized to open one or more locked doors at the other building during the time period. As such, user 207 can enter the other building unassisted to attend meeting 242.

If trip offer 216 is confirmed (YES at 314), method 300 includes formulating a confirmation (320) and sending the confirmation (321). For example, application 201 can formulate confirmation 221 confirming acceptance of trip 236 and send confirmation 221 to trip management service 231. Method 300 includes receiving the confirmation (326) and processing the confirmation (327). For example, trip management service 231 can receive confirmation 221 from application 201. Trip management service 231 can process confirmation 221 to allocate a vehicle for trip 236. Trip management service 231 can update routing database 203 to indicate that the vehicle is allocated for trip 236. Thus, when other trip requests request a vehicle during the time of trip 236, trip management service 231 knows that the vehicle is already allocated for trip 236 and can optimize allocation of other vehicles for other trips based on that knowledge.

Method 300 includes generating an update signal (328) and sending the update signal (329). For example, from time to time, trip management service 231 can generate an update signal 227 (FIG. 2B) and send the update signal 227 to application 201. Update signal 227 can indicate the status of trip 236 (e.g., on time, delayed, maintenance issue, traffic congestion, etc.). Method 300 includes receiving the update signal (330). For example, application 201 can receive update signal 227 from trip management service 231. Method 300 includes presenting ride status to the user (331). For example, application 201 can present ride status 222 (indicated in update signal 227) to user 207 at user interface 247.

In some aspects, “one click” scheduling of a trip is facilitated through a user interface. For example, method 300 can be activated when a user selects a single user interface control from a user interface. “One click” scheduling streamlines trip scheduling promoting earlier scheduling of trips. Generally, the early trips are scheduled, the better trip management service 231 can optimize available resources (e.g., vehicles) to satisfy trip requests.

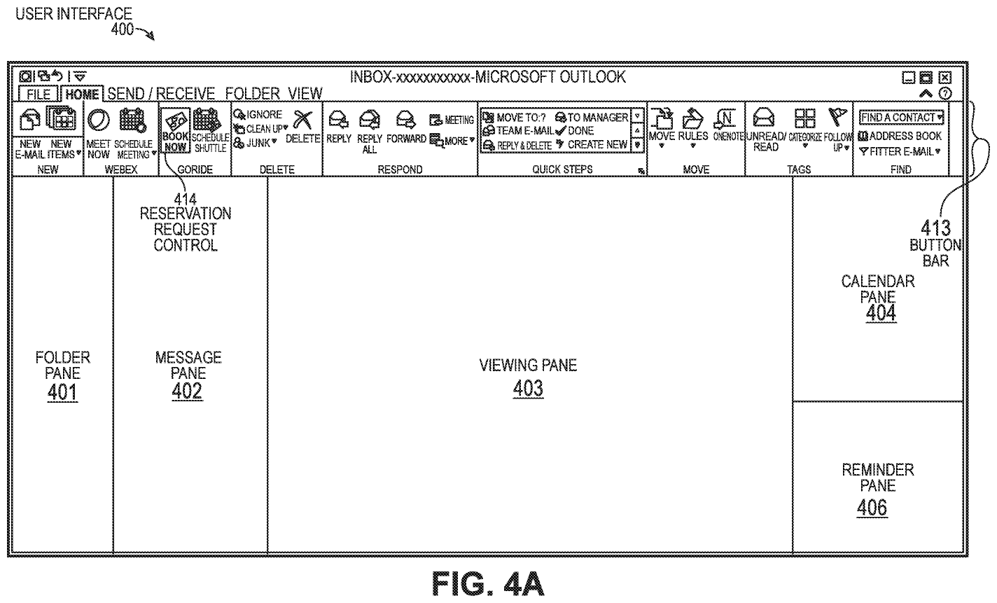

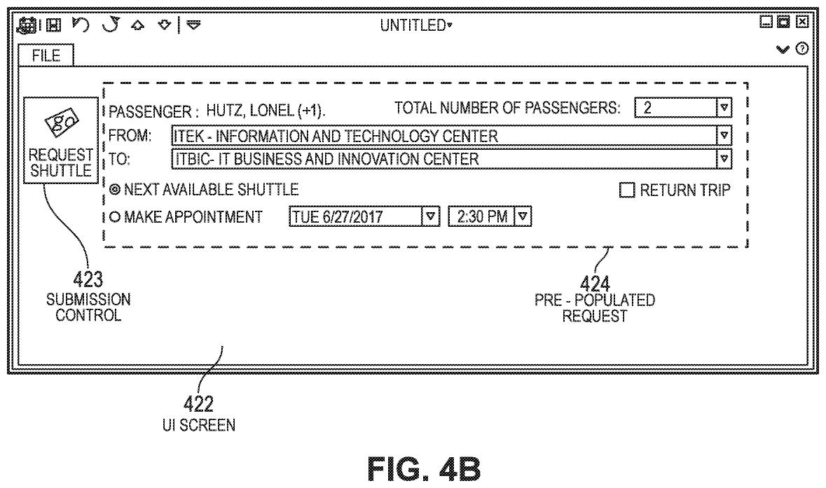

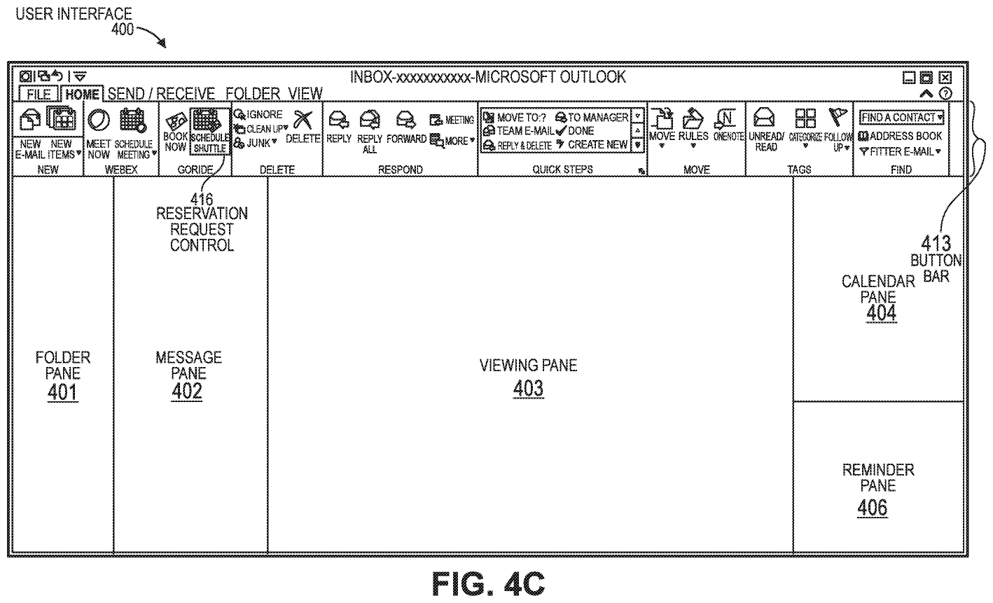

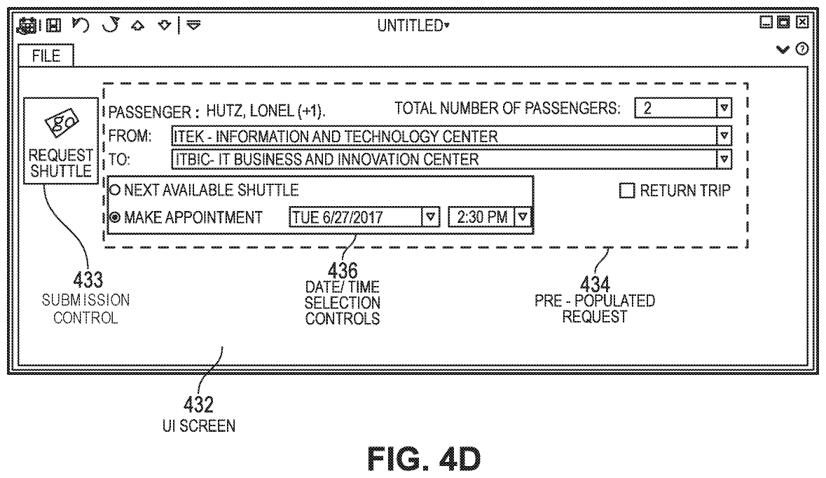

FIG. 4A illustrates a user interface 400. As depicted, user interface 400 includes folder pane 401, message pane 402, viewing pane 403, calendar pane 404, reminder pane 406, and button bar 413. Folder pane 401 can present one or more selectable folders. Message pane 402 can present one or more selectable messages from a currently selected folder. Calendar pane 404 can present one or more meetings/events, for example, selectable in a monthly, weekly, or daily view. Reminder pane 406 can present one or more reminders. Viewing pane 403 can present the content, details, etc. of a selected item (e.g., a message item, a calendar item, a reminder item, etc.).

As depicted, button bar 413 includes reservation request control 414 providing a “book now” option for requesting a shuttle. A user (e.g., user 207) can select (e.g., click on) reservation request control 414 to request the next available shuttle.

FIG. 4B illustrates a user interface screen 422. In response to selection of reservation request control 414, user interface screen 422 can be presented at user interface 400. User interface screen 422 includes pre-populated request 424, including a passenger name, a start location, an end location, and a number of passengers. Pre-populated request 424 also indicates that the user is requesting the next available shuttle. When appropriate, the user can also request scheduling of a return trip at user interface screen 422 (e.g., based on a scheduled end time for a meeting and a return distance/travel time). Pre-populated request 424 can be populated with personnel and meeting data from a human resources/calendar database (e.g., human resources/calendar database 204). The user can select submission control 423 to request a shuttle (and possibly a return shuttle) from a trip management service (e.g., from trip management service 231) that satisfies user travel requirements based the contents of pre-populated request 424.

FIG. 4C illustrates the user interface 400. As depicted, button bar 413 also includes reservation request control 416 providing a “schedule shuttle” option for requesting a shuttle. A user (e.g., user 207) can select (e.g., click on) reservation request control 416 to request a schedule for a specified date and time.

FIG. 4D illustrates a user interface screen 432. In response to selection of reservation request control 416, user interface screen 432 can be presented at user interface 400. User interface screen 432 includes pre-populated request 434, including a passenger, a start location, an end location, and a number of passengers. Pre-populated request 434 also indicates the user desires a shuttle “TUE Jun. 27, 2017 2:30 PM”. The user can use date/time selection controls 436 to change a desired shuttle time. When appropriate, the user can also request scheduling of a return trip at user interface screen 432 (e.g., based on a scheduled end time for a meeting and a return distance/travel time). Pre-populated request 434 can be populated with personal data and meeting data from a human resources/calendar database (e.g., human resources/calendar database 204). The user can select submission control 433 to request a shuttle (and possibly a return shuttle) from a trip management service (e.g., from trip management service 231) that satisfies user travel requirements based the contents of pre-populated request 434.

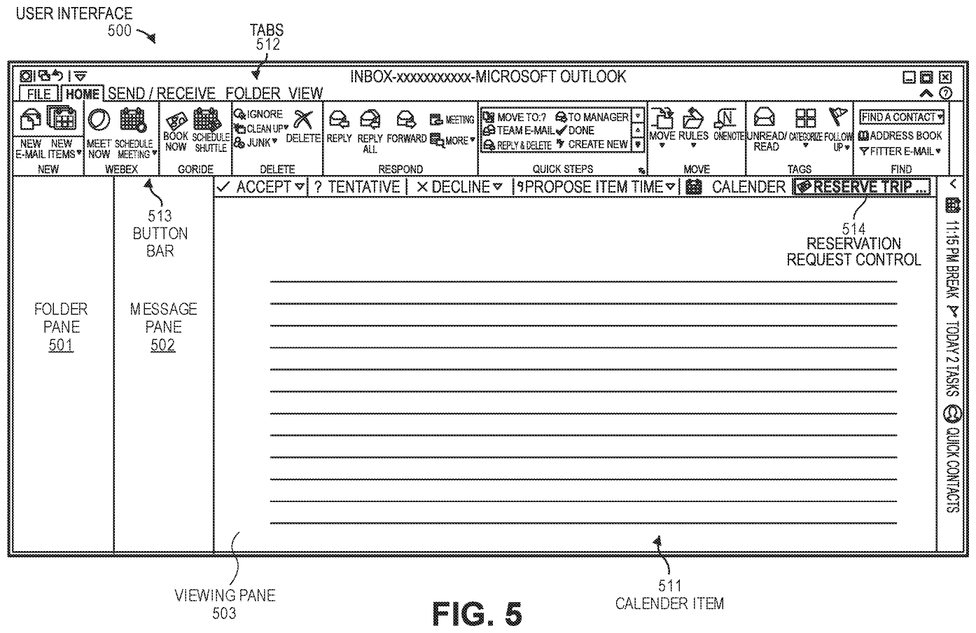

In some aspects, a trip reservation request control is presented along with item data in a viewing pane. FIG. 5 illustrates a user interface 500. As depicted, user interface 500 includes folder pane 501, message pane 502, viewing pane 503, tabs 512, and button bar 513 (a calendar pane and a reminder pane are minimized to the right of viewing pane 503). Folder pane 501 can present one or more selectable folders. Message pane 502 can present one or more selectable messages from a currently selected folder. Viewing pane 503 can present the content, details, etc. of a selected item (e.g., a message item, a calendar item, a reminder item, etc.). As depicted, calendar item 511 is presented at viewing pane 503. Along with user interface controls to accept, tentative, decline, propose a new time, and view calendar, user interface 500 includes reservation request control 514 providing a “reserve trip” option for requesting a shuttle in association with calendar item 511.

A user (e.g., user 207) can select (e.g., click on) reservation request control 514 to request a shuttle for a specified date and time. In response to selection of reservation request control 514, a user interface screen similar to user interface screen 432 can be presented at user interface 500. The user interface screen can include a shuttle request pre-populated with personnel data and meeting data for calendar item 511 from a human resources/calendar database (e.g., human resources/calendar database 204). The meeting data can include a passenger name, a start location, an end location, a number of passengers, a date, and a time. When appropriate, the user can also request scheduling a return trip at the user interface screen. The user can select a submission control (e.g., similar to submission control 433) to request a shuttle (and possibly a return shuttle) from a trip management service (e.g., from trip management service 231) that satisfies user travel requirements based the contents of the pre-populated request (associated with calendar item 511).

A security service (e.g., security service 232) can provide a map of a destination building. The map can indicate a path from a building entrance to a meeting location and can also indicate that a user is cleared to physically enter the destination building unassisted.

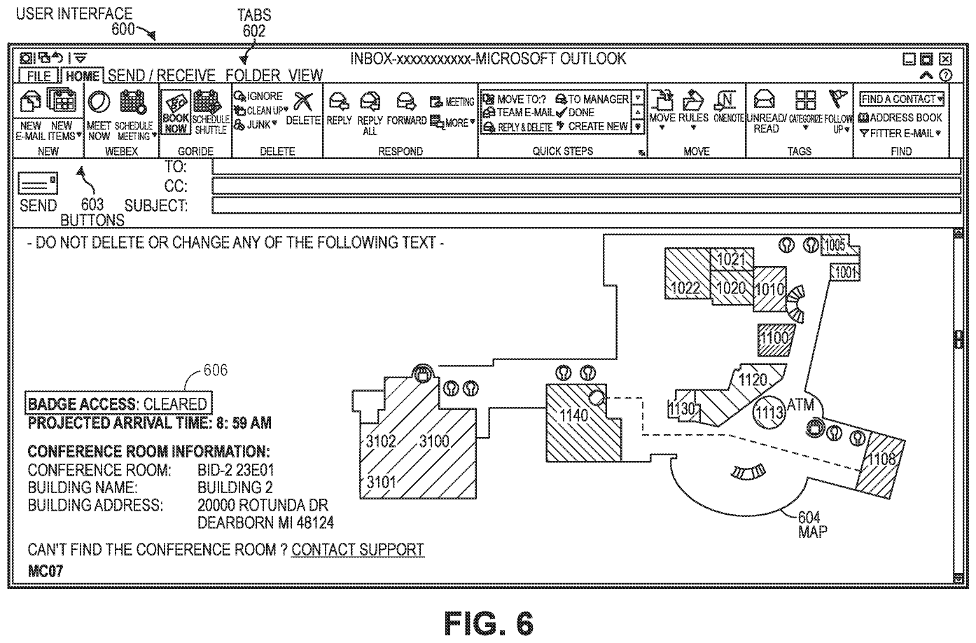

FIG. 6 illustrates a user interface 600 including tabs 602 and buttons 603. User interface 600 indicates a map to a meeting location. As depicted, user interface 600 includes a route (the dashed line) from 1108 (e.g., an entrance) to 1140 (e.g., a conference room). Text 606 indicates that a user's badge access is cleared to enter the building. As such, upon reaching a destination building, a user may be able to enter the destination building unassisted and proceed efficiently along the route from 1108 to 1140.

As the time of a scheduled trip approaches (e.g., within 15 minutes of a trip, within 5 minutes of a trip, etc.), a calendar database (e.g., calendar database 204) can send a reminder to an application (e.g., application 201). The application can present the reminder at a user interface (e.g., at user interface 247, 400 or 600).

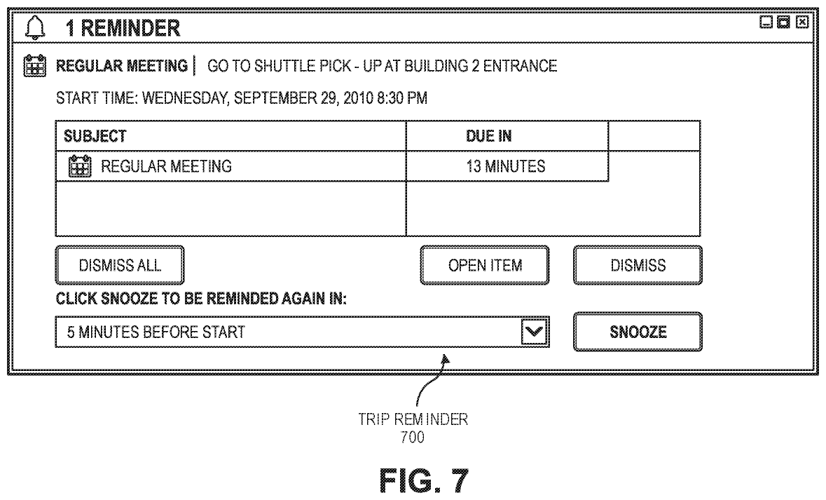

FIG. 7 illustrates a trip reminder 700. A human resources/calendar database can formulate reminder 700 for an approaching trip. The human resources/calendar database can send reminder 700 to an application. The application can present reminder 700 at a user interface to reminder a user of the approaching trip.

In general, application 201 can include any of the functionality described with respect to user interface 400, user interface screens 422 and 432, user interface 500, user interface 600, and trip reminder 700. As such, user interface 247 can also include and/or present any of the elements depicted in user interface 400, in user interface screens 422 and 432, in user interface 500, in user interface 600, and in trip reminder 700.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, meeting requests, meeting data, user trip requests, trip queries, trip information, completed trip requests, trip offers, trip reminders, confirmations, building access requests, update signals, ride status, calendar items, maps, etc.

System memory can be coupled to the one or more processors and can store instructions (e.g., computer-readable instructions, computer-executable instructions, etc.) executed by the one or more processors. The system memory can also be configured to store any of a plurality of other types of data generated by the described components, such as, for example, meeting requests, meeting data, user trip requests, trip queries, trip information, completed trip requests, trip offers, trip reminders, confirmations, building access requests, update signals, ride status, calendar items, maps, etc.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash or other vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications, variations, and combinations are possible in light of the above teaching. Further, it should be noted that any or all of the aforementioned alternate implementations may be used in any combination desired to form additional hybrid implementations of the disclosure.

1. A method comprising:
receiving a trip request from an application to schedule a trip to an event;
using data in the trip request to query a calendar database for additional relevant event information;
sending a further trip request populated with the additional relevant event information to a trip management service to request a trip satisfying the trip request; and
receiving user confirmation of a trip offered from the trip management service to the user.

2. The method of claim 1, wherein receiving a trip request from an application to schedule a trip to an event comprises receiving a request including a user identifier and a meeting identifier.

3. The method of claim 3, wherein using data in the trip request to query a calendar database for additional relevant event information comprises:
querying the calendar database with the user identifier and the meeting identifier;
in response to the query, receiving the location of a building containing a user's office, a location of another building where the event is to occur, a date of the event, and a starting time of the event; and
auto populating the trip request with the location of the building, the location of the other building, the date, and the start time to formulate the further trip request.

4. The method of claim 1, further comprising sending a building access request to request temporary physical access to the other building on the date of the event around the start time of the event.

5. The method of claim 1, wherein receiving a trip request from an application to schedule a trip to an event comprises receiving the trip request in response to user selection of a user interface control at a user interface of the application.

6. The method of claim 5, wherein receiving the trip request in response to user selection of a user interface control at a user interface of the application comprises receiving the trip request in response to user selection of a trip request user interface control integrated into a user interface of a calendaring system application.

7. A method comprising:
sending a trip request to a request builder to schedule a trip to an event, the event scheduled for a date and a start time at a building;
receiving a trip offer from a trip management service offering a trip purported to satisfy the trip request based on the date, the start time, and the building location;
receiving user acceptance of the trip offer through a user interface control integrated into a calendar system application; and
in response to user acceptance of the trip, automatically:
sending a building access request to a security service to request temporary access to the building on the date of the event around the start time of the event;
sending a trip reminder to a calendar database; and
sending a confirmation to the trip management service.

8. The method of claim 7, wherein sending a trip request to a request builder to schedule a trip to an event comprises sending a trip request in response to user selection of another user interface control integrated into the calendar system application.

9. The method of claim 8, wherein sending a trip request in response to user selection of another user interface control integrated into the calendar system application comprises sending a trip request in response to user selection of the other user interface control from a viewing pane of a user interface.

10. The method of claim 8, further comprising:
receiving an invitation to the event;
receiving user acceptance of the invitation through a further user interface control integrated into the calendar system application; and
storing the date, the start time, and the building in the calendar database in association with the user.

11. The method of claim 7, wherein sending a trip request to a request builder to schedule a trip to an event comprises sending a request to schedule a corporate shuttle.

12. The method of claim 7, wherein receiving a trip offer from a trip management service comprises receiving a trip offer for a trip formulated based on an estimated travel time from the user's office location to the building location.

13. The method of claim 7, further comprising tracking the user's physical access to the building on the date of the event around the start time of the event.

14. The method of claim 7, further comprising:
querying the calendar database with a user identifier of the user and the meeting identifier of the event;
in response to the query, receiving the location of another building containing the user's office, the building location, the date, and the start time; and
auto populating the trip request with the location of the other building, the building location, the date, and the start time.

15. The method of claim 14, further comprising receiving a user request to schedule a return trip from the building location to the location of the other building after the event.

16. The method of claim 7, further comprising receiving a map of the building indicating a route from a building entrance to a room inside the building scheduled for the event.

17. A system comprising:
a processor; and
system memory coupled to the processor and storing instructions configured to:
present a meeting invitation at a user interface of a calendar system application, the meeting invitation inviting a user to a meeting to be held at a date and a start time in a room of a building;
receive user selection of an invitation acceptance user interface control integrated into the user interface, user selection of the invitation acceptance user interface control indicating acceptance of the invitation;
store the date, the start time, the room, and the building in the calendar database in association with the user;
receive user selection of a trip request user interface control integrated into the user interface, user selection of the trip request user interface control sending a trip request to schedule a vehicular trip to the meeting;
receive a trip offer from a trip management service offering a trip purported to satisfy the trip request based on the date, the start time, and the building location;
receive user selection of a trip acceptance user interface control integrated into the user interface, user selection of the trip acceptance user interface control indicating acceptance of the trip offer; and
in response to user acceptance of the trip offer, automatically:
send a building access request to a security service to request temporary access to the building on the date of the event around the start time of the event;
store a trip reminder in the calendar database; and
send a confirmation to the trip management service.

18. The system of claim 17, wherein instructions configured to receive a trip offer from a trip management service offering a trip purported to satisfy the trip request comprises instructions configured to receive a trip offer formulated based on an estimated travel time from a location of another building containing the user's office to a location of the building.

19. The system of claim 17, further comprising instructions configured to receive user selection of a return trip user interface control integrated into the user interface, user selection of the return trip user interface control indicating a user request to also schedule a return trip from the location of the building to the location of the other building after the event.

20. The system of claim 17, further comprising instructions configured to:
receive a map of the building indicating a route from a building entrance to the room; and
present the map at the user interface.
